(19) United States
(12) Patent Application Publication
(10) Pub. No.: US 2026/0298212 A1
(43) Pub. Date: Oct. 1, 2026

(54) IMPROVEMENTS RELATING TO WIND TURBINE NACELLES

(71) Applicant: Vestas Wind Systems A/S, Aarhus N. (DK)

(72) Inventors: Morten Bagger Søgaard, Thisted (DK); Yucel Baki, Porto (PT); Guilherme Pacheco, Porto (PT); Omprakash Thachanamoorthy, Chennai (IN)

(73) Assignee: Vestas Wind Systems A/S, Aarhus N. (DK)

(21) Appl. No.: 19/491,005

(22) PCT Filed: May 24, 2024
(86) PCT No.: PCT/DK2024/050123

§ 371 Date: Dec. 8, 2025

(30) Foreign Application Priority Data
Jun. 27, 2023 (DK) PA202370340

(51) Int. Cl. F03D 80/80; F03D 1/00; F03D 13/10; F03D 13/40

(52) U.S. Cl. CPC F03D 80/821; F03D 1/141; F03D 1/181; F03D 13/116; F03D 13/135; F03D 13/403

(57) ABSTRACT

A wind turbine nacelle having a base frame comprising a nacelle mounting ring including a mounting face adapted to be mountable to a wind turbine tower. The nacelle mounting ring has an open central aperture that, in use, conjoins an interior volume of the nacelle and an interior volume of the tower, wherein the mounting face defines a mounting plane. The wind turbine nacelle includes at least one electrical cabinet that is movably coupled, either directly or indirectly, to the base frame at a coupling point or, more simply, ‘coupling’, to move between a first and a second position. The coupling point is located within a cylindrical volume defined by and concentric with a diameter of the nacelle mounting ring, and which extends upwards from the mounting plane by a perpendicular distance corresponding to 80% of the diameter of the nacelle mounting ring and which extends downwards from the mounting plane by a perpendicular distance corresponding to 20% of the diameter of the nacelle mounting ring.

### TECHNICAL FIELD

The examples of the invention relate to a wind turbine nacelle that may be configured more conveniently for transport and use.

### BACKGROUND TO THE INVENTION

A typical Horizontal Axis Wind Turbine (HAWT) comprises a tower, a nacelle on top of the tower, a rotor hub mounted to the nacelle and a plurality of wind turbine rotor blades coupled to the rotor hub. Depending on the direction of the wind, the nacelle and rotor blades are turned and directed into an optimal direction by a yaw system for rotating the nacelle and a pitch system for rotating the blades.

The nacelle houses many functional components of the wind turbine, including a main rotor shaft and one or more electrical generators, as well as convertor equipment for converting the mechanical energy at the rotor into electrical energy for provision to the grid. Additionally, the nacelle houses various control units to support the various subsystems of the wind turbine, for example, a yaw system.

Generally, it is desirable to limit the overall size of a nacelle to benefit operation, shipping and handling. However, the increasing complexity of wind turbine systems means that wind turbine nacelles are required to accommodate a growing number of system components which compromises the space available within the nacelle. It is therefore desirable to arrange components within the nacelle as space-efficiently as possible.

It is against this background that the present invention has been devised.

### SUMMARY OF THE INVENTION

According to a first aspect of the invention, there is provided a wind turbine nacelle. The wind turbine nacelle has a base frame comprising a nacelle mounting ring having a mounting face adapted to be mountable to a wind turbine tower, the nacelle mounting ring having an open central aperture that, in use, conjoins an interior volume of the nacelle and an interior volume of the tower, wherein the mounting face defines a mounting plane. The wind turbine nacelle includes at least one electrical cabinet that is movably coupled, either directly or indirectly, to the base frame at a coupling point or, more simply, ‘coupling’, to move between a first and a second position. The coupling point is located within a cylindrical volume defined by and concentric with an outer diameter of the nacelle mounting ring, and which extends upwards from the mounting plane by a perpendicular distance corresponding to 80% of the outer diameter of the nacelle mounting ring and which extends downwards from the mounting plane by a perpendicular distance corresponding to 20% of the outer diameter of the nacelle mounting ring.

In the first position, the at least one electrical cabinet may be located above the mounting plane. Furthermore, in moving to the second position, the at least one electrical cabinet may move through the central aperture such that at least a portion of the at least one electrical cabinet is located below the mounting plane. In an example, the at least one electrical cabinet may be located entirely beneath the mounting plane when in the second position.

Beneficially, this design allows utilisation of space within the nacelle that is otherwise unusable during operation. For example, by temporarily packaging the at least one electrical cabinet inside the nacelle volume during transport, the nacelle can be placed on a ship or a trailer without risk of damage to the electrical cabinets. Upon installation of the nacelle on the wind turbine tower, the electrical cabinets are moved to the second position that is compatible with operation and may utilise space within the tower that is otherwise unused. By using pre-existing space within the wind turbine in this manner, the interior volume requirements of the nacelle are reduced.

Further, as a nacelle undergoes testing at the factory where it is produced, all systems and components must be present in the nacelle before it leaves the factory. Furthermore, it is undesirable for any components or systems to be disassembled or disconnected from the nacelle after testing as this may invalidate the system test results.

Positioning electrical cabinets close to the mounting features of the nacelle on the tower presents an issue of access to the various fasteners and features required to attach the nacelle to the tower. By movably coupling these electrical cabinets, they can be moved to allow operators access to complete any required assembly works before being moved back into position after the works have been completed.

Therefore, it is an object of the invention to provide a means of movably coupling components within the nacelle that supports transport and assembly of the nacelle to the wind turbine tower.

The at least one electrical cabinet may be coupled, either directly or indirectly to the base frame at the coupling point by a hinge. In an alternative example, the electrical cabinet is movable to translate along a predefined linear path between the first and the second position rather than an arcuate path as would be the result of a hinged connection. In other examples, the at least one movably coupled electrical cabinet may be configured to swing through an arcuate path between the first and second positions during which the orientation of said cabinet stays the same, as may be achievable with a four-bar linkage style mechanism.

The at least one electrical cabinet may relate to a wind turbine yaw system. Advantageously, locating electrical cabinets relating to the wind turbine yaw system nearby to other components of the yaw system that are required to be controlled reduces cable length between the components, thereby reducing cost and complexity of the yaw system as a whole.

The wind turbine nacelle may include a plurality of electrical cabinets that are movably coupled, either directly or indirectly, to the base frame at respective coupling points. The plurality of electrical cabinets may be spaced circumferentially about the central aperture. In either of these scenarios, the plurality of electrical cabinets may be arranged such that, when at least one of the movably coupled electrical cabinets is in the second position, an access space is defined between the plurality of movably coupled electrical cabinets and through the central aperture.

The base frame may comprise a hollow interior space and, in this instance, the coupling point may be adapted such that the at least one electrical cabinet is movable within the hollow interior space.

The outer diameter of the mounting ring may be greater than 2 meters, optionally greater than four meters.

The at least one electrical cabinet may remain operatively coupled to an electrical system within the nacelle during movement of the electrical component.

The inventive concept embraces a wind turbine including a nacelle as defined above.

The examples of the invention may also extend to a method of installing a nacelle as defined above on a wind turbine tower, in which the method may comprise: transporting the nacelle to the tower in a transport condition, wherein in the transport condition the at least one movably coupled component is in the first position; assembling the nacelle on the wind turbine tower; and moving the at least one movably coupled component from the first position to the second position. Optionally, the at least one movably coupled component is moved from the first position to the second position through the open central aperture.

### BRIEF DESCRIPTION OF THE DRAWINGS

The invention will now be described, by way of example only, with reference to the attached drawings, in which:

FIG. 1 is a perspective view of a horizontal axis wind turbine within which examples of the invention may be incorporated, including a nacelle mounted on top of a tower;

FIG. 2 shows a schematic view where the nacelle is mounted on top of the wind turbine tower;

FIG. 3 shows a simplified schematic view of the interior of the nacelle, similar to that of FIG. 2, in a transport condition;

FIG. 4 shows an example base frame and main bearing housing of a wind turbine for further context;

FIG. 5 shows a simplified schematic view where the nacelle is mounted on top of the wind turbine tower, similar to that of FIG. 2, but illustrating a zone within which electrical cabinets may be mounted within the nacelle.

### DETAILED DESCRIPTION

An example of the invention will now be described in which numerous features will be discussed in detail in order to provide a thorough understanding of the inventive concept as defined in the claims. However, it will be apparent to the skilled person that the invention may be put into effect without the specific details and that in some instances, well known methods, techniques and structures have not been described in detail in order not to obscure the invention unnecessarily.

In overview, the examples of the invention provide a wind turbine having a nacelle in which one or more internal components are configured to make more efficient use of the space within the nacelle. The examples of the invention apply particularly to components of a yaw system of the nacelle, in particular electrical panels, cabinets and cubicles. In particular, one or more electrical cabinets of the nacelle are configured to be movably coupled to the nacelle in such a way that they can be configured in a first state or position during transport of the nacelle but can also be configured in a second state or position for operational use of the nacelle. Conveniently, in moving to the second position the movably coupled electrical cabinets can descend at least partly into the interior of the tower so that they take up less room in the nacelle. This provides a more space-efficient arrangement.

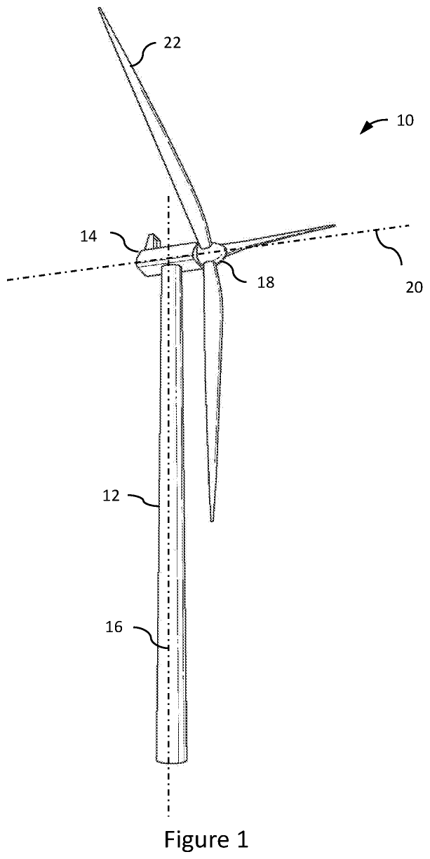

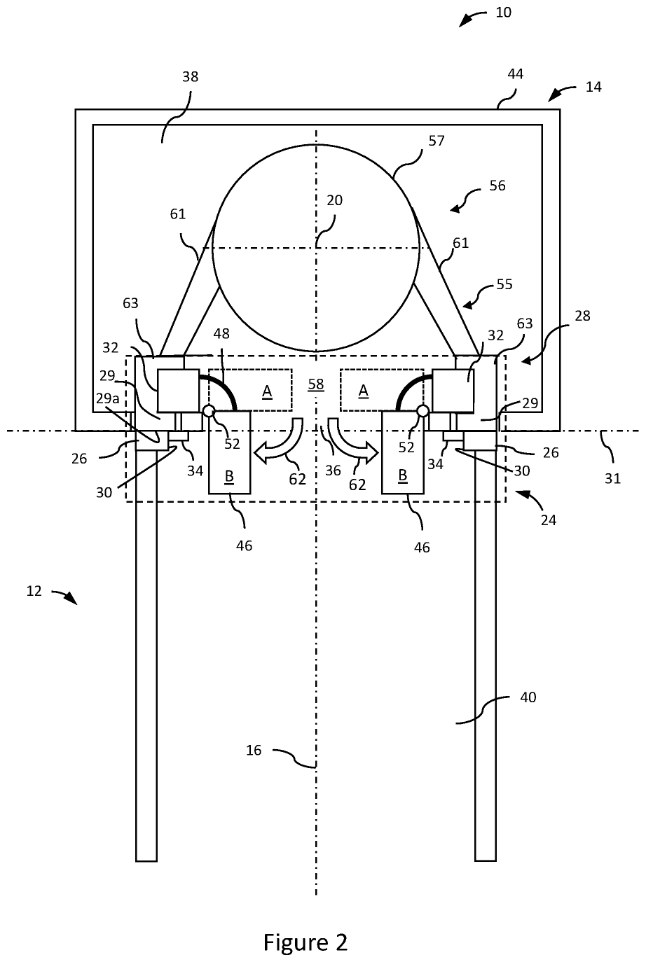

In order to place the embodiments of the invention in a suitable context, reference will firstly be made to FIG. 1, in which a wind turbine 10 comprises a tower 12 and a nacelle 14 that is coupled to the top of the tower 12 by a yaw system so that the nacelle 14 can move angularly about a yaw axis 16. Note that the yaw system is not shown in FIG. 1 but is shown in FIG. 2 in schematic form.

The nacelle 14 supports a rotor hub 18 that is coupled to the nacelle 14 so that it can rotate about a rotor axis 20. The rotor hub 18 comprises a set of wind turbine rotor blades 22 that capture energy from an oncoming flow of wind and transmit torque to the rotor hub 18. The nacelle 14 and therefore the rotor blades 22 are turned and directed into the wind by the yaw system to harvest energy from the wind.

The nacelle 14 houses many functional components of the wind turbine 10, including the main rotor shaft, generator, gearbox, and power converter for converting the mechanical energy of the wind into electrical energy for provision to the grid.

The tower 12 is a hollow elongate vertical structure that is tall enough to allow ample clearance of the moving rotor blades 22 to the ground. The tower 12 may typically comprise features to allow personnel to access the nacelle 14 from ground level such as stairs, ladders, platforms and so on. The outer diameter of the tower 14 may vary depending on the overall size and power generation capacity of the wind turbine. However, for utility scale wind turbines, the diameter of the tower is in excess of 2 metres, and preferably in excess of 4 metres.

FIG. 2 shows a simplified schematic interior view of the nacelle 14 positioned on top of the tower 12. As mentioned above, the nacelle 14 is rotatably coupled to the tower 12 by a yaw system, as is well known in the art, and as is indicated here generally as 24.

The yaw system 24 comprises a yaw ring 26 situated between the tower 12 and the nacelle 14 which permits the nacelle 14 to rotate relative to the tower 12.

The yaw ring 26 may be fixed to the top of the tower 12 by an appropriate method such as a set of bolts (not shown) and provides a part of a slide bearing formation for the nacelle 14, as is known in the art. Conventionally, slide bearings are used because they are well-suited to cope with the high loads that are generated from the mass of the nacelle 14 and the applied forces of wind turbine 10 operation. It should be appreciated, however, that other forms of bearings, such as roller bearings, may be appropriate in some configurations.

The yaw ring 26 engages or interfaces with a base frame 28 of the nacelle 14. Together, the yaw ring 26 and the base frame 28 permit the nacelle 14 to rotate relative to the tower 12 about the yaw axis 16, as will be described. The yaw ring 26 further comprises a gear surface 30 which faces radially inwards with respect to the yaw axis 16. Note that in some arrangements, this configuration may be reversed such that the gear surface 30 faces radially outwards.

The yaw system 24 further comprises at least one yaw drive 32. The at least one yaw drive 32 is supported by and fixed to the base frame 28 and includes a yaw gear 34 that is engaged with the gear surface 30 of the yaw ring 26. The location of the yaw drive 32 is not intended to be limiting, as there are alternative examples of yaw drive mounting arrangements and locations known in the art.

As the yaw ring 26 is fixed relative to the tower 12 and the at least one yaw drive 32 is fixed relative to the nacelle 14, operation of the at least one yaw drive 32 causes rotation of the nacelle 14 relative to the tower 12 about the yaw axis 16. The yaw drive 32 may take any suitable form, and conventionally comprises electrically or hydraulically driven motors. At this point it should be noted that two yaw drives 32 are provided although in practice there may be more than this, for example between four and fourteen yaw drives 32.

The base frame 28 of the nacelle 14 is configured to transmit the forces of the wind acting on the rotors 22 through to the tower 12 during operation. The base frame 28 is slidingly coupled to the yaw ring 26, in a face-to-face relationship, allowing relative movement between the nacelle 14 and the tower 12 about the yaw axis 16. The base frame 28, sometimes referred to as a bed plate, is typically a cast steel component that provides support for a main bearing housing of the nacelle 14, a support structure for an outer shell or skin 44 of the nacelle 14, as well as providing the main interface between the nacelle 14 and the tower 12.

More specifically, to enable the sliding interface between the base frame 28 and the yaw ring 26, the base frame 28 comprises a nacelle mounting ring 29. The nacelle mounting ring 29 is suitably configured with a mounting face 29a that is in sliding face-to-face contact with the yaw ring 26.

The transition between the base frame 28 and the tower 12 is demarked by a mounting plane 31 in FIG. 2 which is coincident with the mounting face 29a of the nacelle mounting ring 29. The base frame 28 defines an open central area or aperture 36 that that spans the mounting plane 31 and provides an entry point from the interior volume 40 of the tower 14 to the interior volume 58 of the base frame 28, thereby conjoining the two volumes.

The interior volume 58 of the base frame 28 is located above the mounting plane 31 of the base frame 28. Similarly, the interior volume of the tower 40 is defined by the volume enclosed by the hollow elongate structure of the tower 12 and terminates at the mounting plane 31. It should be noted that it is possible for an operator to access the interior volume 38 of the nacelle 14 from the interior volume 58 of the base frame 28 also.

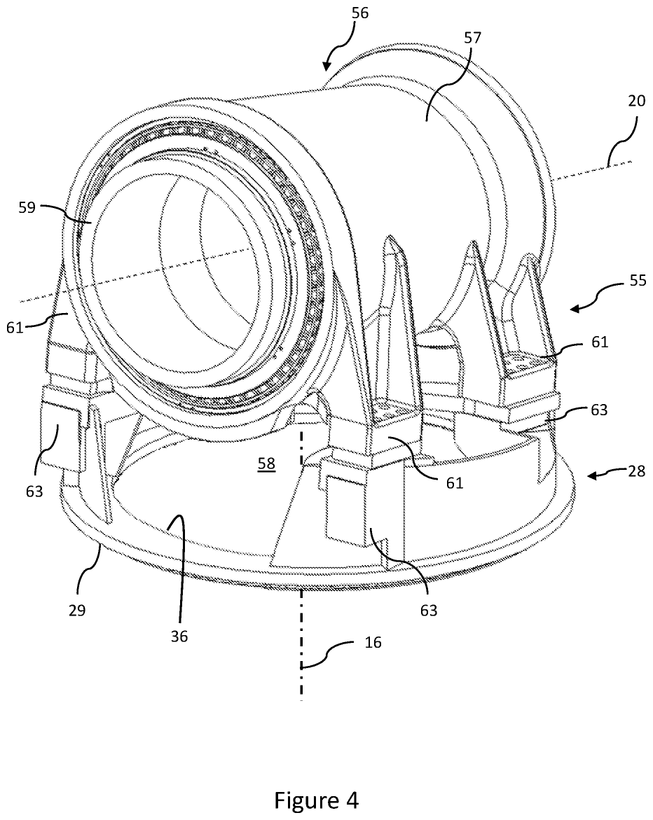

For context, reference will also now be made to FIG. 4 which shows an example of a more practical realisation of the base frame 28 in perspective view. Here, it will be appreciated that the nacelle mounting ring 29 of the base frame 28 can be seen in a lower position, above which is mounted a main bearing housing 56 comprising a suitably configured support structure 55.

The main bearing housing 56 may take various forms but is shown here as including generally tube-shaped body 57 which houses a main shaft 59 of the rotor hub 18 (main shaft 59 is not shown in the schematic view of FIG. 2). The support structure 55 of the main bearing housing 56 comprises four support legs 61 in this example which are mounted on respective upstanding platforms or pedestals 63 of the base frame 28. A bolted connection may suitably be used to connect the support structure 55 to the pedestals 63, although this is not shown in the Figures for the sake of clarity. It should be noted that the legs 61 of the support structure 55 form a single part with the body 57 of the main bearing housing 56, in this example, although the monolithic or integral nature of the components is not essential.

By virtue of this arrangement, the open interior volume 58 of the base frame 28 is defined between the underside of the main bearing housing 56 and above the nacelle mounting ring 29. The interior volume 58 above the nacelle mounting ring 29 is typically preferred to remain an uncluttered volume so that maintenance workers can climb into the interior volume 38 of the nacelle 14 from the tower 12 through the open central aperture 36.

Returning again to FIG. 2, the base frame 28 is configured so that the yaw drives 32 are positioned about the perimeter of the central aperture 36. The central aperture 36 allows personnel access to the interior volume 58 of the base frame 28 from the interior volume 40 of the tower 12 and to allow power cables and the like (not shown) to pass down through the interior volume 40 of the tower 12.

The one or more yaw drives 32 are operatively coupled to respective electrical cabinets or cubicles 46. As would be understood by the skilled person, the electrical cabinets 46 house the necessary control electronics to control the operation of the respective yaw drives 32. The electrical cabinets 46 are movably coupled, either directly or indirectly, to the nacelle 14 and, more specifically, the base frame 28. To accommodate the movement of the electrical cabinets 46, they are operatively coupled to the respective yaw drives 32 by control cables 48 which remain coupled throughout the movement of the electrical cabinet 46.

The electrical cabinets 46 are movably coupled to the base frame 28 between a first position and a second position. The first position is indicated by ‘A’ in FIG. 2 and is shown in dashed lines, whereas the second position is indicated at ‘B’ and shown in solid lines.

In this example, in the first position A the electrical cabinets 46 are located above the mounting plane 31 and so are therefore contained within the interior volume 58 of the base frame 28. In the second position B at least a portion of the electrical cabinets 46 are located below the mounting plane 31, and so at least part of the electrical cabinets 46 are located in the interior volume 40 of the tower 12. It will be noted that the larger part of the electrical cabinets 46 are located below the mounting plane 31, whereas a minor part is located above the mounting plane 31. In some examples, the movably coupled electrical cabinets 46 may be configured so that in the second position B the entirety of the electrical cabinets 46 are located below the mounting plane 31. It will be appreciated that in moving from the first position A to the second position B, the electrical cabinets 46 traverse through the central aperture 36.

Beneficially, locating the electrical cabinets 46 close to the respective yaw drives 32 means that the need for extended looms of control cabling 48 is reduced. In a typical nacelle configuration, the control electronics for the yaw drives 32 may be located deep into the nacelle 14 which would require tens of meters of control cabling 48 at a considerable mass penalty. Reducing the length of control cabling 48 required realises a significant mass reduction.

Moreover, the nearby location of the electrical cabinets 46 to the respective yaw drives 32 means that space within the interior volume 38 of the nacelle 14 is freed up for other components which is a significant packaging benefit. As will be noted in FIG. 2, in the second position B the electrical cabinets 46 are swung downwards so that they are largely contained within the interior volume 40 of the tower 12, demonstrating the space saving made within the nacelle 14. However, the electrical cabinets 46 are still readily accessible by maintenance personnel. Conveniently, the fact that the electrical cabinets 46 are mounted in such a way that they can be swung throughout a range of positions, means that an improvement in access is achieved because the electrical cabinets 46 are reachable from both sides. Typically, such electrical cabinets 46 are accessible from one side only because they are on a fixed mounting, so to be able to access them from both sides can provide a benefit during maintenance. Additionally, the electrical cabinets 46 are intended to remain operatively coupled throughout movement to the electrical systems of the nacelle to which they interact. Thereby allowing maintenance personnel access without compromising the functionality of the system as a whole.

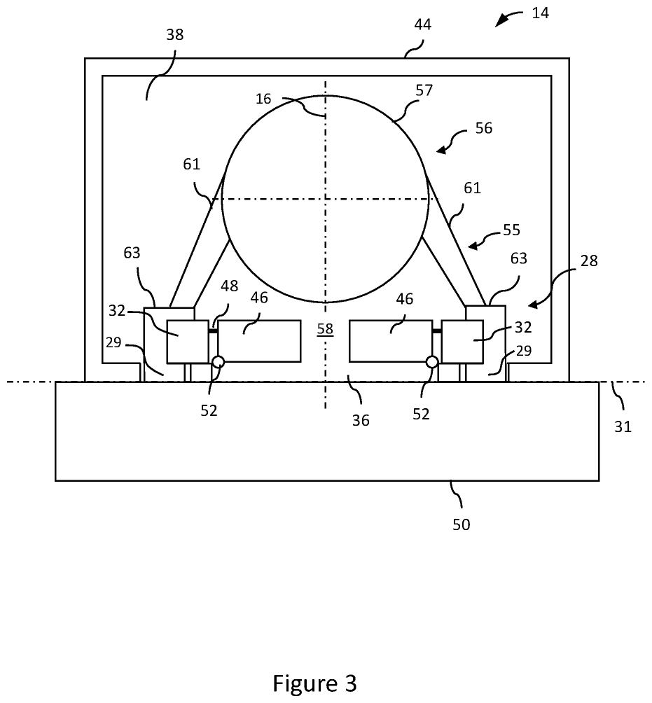

Locating the electrical cabinets 46 in the interior volume 58 of the base frame 28 immediately above the central aperture 36 may restrict access into the nacelle 14 from the tower 12. So, in the second position B, the position and orientation of the electrical cabinets 46 leaves open a central crawlspace or access way for maintenance personnel to climb into the nacelle 14. However, the location of the electrical cabinets 46 in the first position A is particularly useful during transport of the nacelle 14 since it means that the electrical cabinets 46 do not extend downward below the mounting plane 31 which could otherwise be problematic for mounting the nacelle 14 to a deck 50 (see FIG. 3) of a transport ship or trailer.

Alternatively, the electrical cabinets 46 may be located in a position in the interior volume 58 of the base frame 28 immediately above the central aperture 36 where, throughout their movement, they do not cross or interact with the mounting plane 31. In this example, the electrical cabinets 46 may restrict access to fasteners for mounting the nacelle 14 to the wind turbine tower 12. Beneficially, an operator could move the electrical cabinets 46 to a less restrictive position to gain access to said fasteners before moving the electrical cabinets 46 back to their original position when the operator is finished with the fasteners.

The electrical cabinets 46 may be mounted in various configurations to enable them to be movable between the first position A and second position B. In the illustrated example, the electrical cabinets 46 are pivotably attached, either directly or indirectly, to the base frame 28 of the nacelle 14 via a hinge 52 at an edge of the central aperture 36, the hinge 52 thereby providing the coupling point of the respective electrical cabinets 46 to the base frame 28, in this example. The configuration of the hinge 52 enables the respective electrical cabinet 46 to swing from the first position A to the second position B. A simple hinge 52 configuration as shown here is an elegant solution to achieve the necessary movement of the electrical cabinets 46. The specific type of hinge, e.g., butt hinge or living hinge, is not important, however. Rather, it is the movable coupling arrangement that provides the functionality of the electrical cabinets 46 being able to be moved between two different positions as herein described.

The position of the hinge 52 influences an arc 62 through which the respective electronic cabinet 46 travels when moving between the first position A and the second position B. The hinge position and subsequent arc of travel 62 is a consideration to ensure that a cabinet 46 does not clash with other electrical cabinets 46 or other components of the wind turbine 10.

The skilled person will appreciate that FIG. 2 demonstrates one example of attaching the electrical cabinets 46 to the base frame 28 to achieve the required movable coupling. In an alternative embodiment, the hinge 52 could be replaced with sliding mechanisms allowing the electrical cabinets 46 to translate between the first and second positions, A and B, along a predefined linear path. For example, the electrical cabinets 46 may be mounted on respective rail systems so that they follow a substantially linear path through the central aperture 36 as they travel between the first position A and the second position B.

Additionally, a sliding mechanism may be adapted to include a hinge or pivot that is configured to slide along the predefined path such that the electrical cabinets 46 may translate and rotate either sequentially or simultaneously with translatory movement.

Such sliding mechanisms may take the form of a track and slider wherein the track defines the path through which the slider translates. The track may be linear or may take a route with curvature.

Additionally, or alternatively, a linkage mechanism could be used as a means of coupling the electrical cabinets 46 to the base frame 28, for example, a four-bar linkage. In this example, the electrical cabinet 46 may move about an arcuate path with or without rotation.

FIG. 3 shows a nacelle 14 in a transport condition, ready to be fitted to a tower 12. The electrical cabinets 46 are shown in the first or “stowed” position A which is appropriate for transportation. The stowed position A ensures that the electrical cabinets 46 are positioned completely within the interior volume 58 of the base frame 28 thereby protecting the electrical cabinets 46 during transport of the nacelle 14, for example, from the manufacturing facility to the installation site. As can be seen in FIG. 3, the electrical cabinets 46 do not extend down beneath the mounting plane 31 which means that they do not interfere with the mounting of the nacelle 14 to the deck 50 of a ship or trailer.

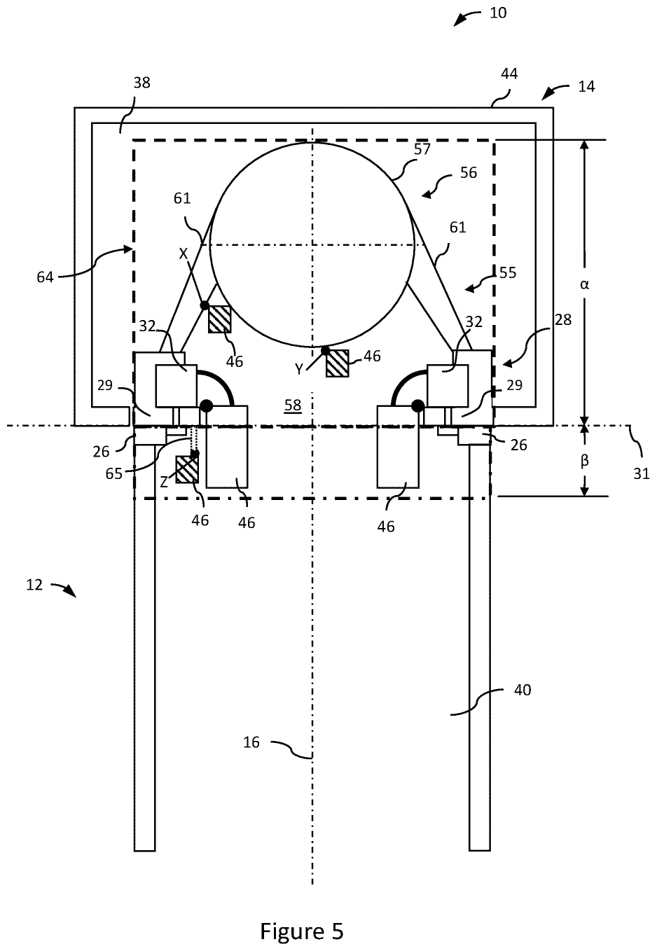

Lastly, FIG. 5, which is similar to FIG. 2, shows an interior view of the nacelle 14 positioned on top of the tower 12. It should be noted that although FIG. 2 shows one option for where the electronics cabinets 46 may be mounted, there are further mounting possibilities that are encompassed by the inventive concept. In particular, FIG. 5 is marked with a cylindrical volume 64, which is defined by and concentric with the diameter of the nacelle mounting ring 29, and, more specifically, the outer diameter thereof. The cylindrical volume 64 extends upwards from the mounting plane 31 by a perpendicular distance a corresponding to 80% of the diameter of the nacelle mounting ring 29 and which extends downwards from the mounting plane 31 by a perpendicular distance β corresponding to 20% of the diameter of the nacelle mounting ring 29. The volume defined by the distances α and β demark a space in which the one or more electronics cabinets 46 may be mounted and located.

In FIG. 5, it will be noted that three exemplary mounting locations or coupling points, are labelled as ‘X’, ‘Y’, and ‘Z’. Locations X and Y demonstrate locations wherein the electrical cabinet 46 remains entirely within the interior volume 58 bounded at least partly by the base frame 28, therefore above the mounting plane 31, throughout its allowable movement. More specifically, it will be noted that at location X the respective electrical cabinet 46 is coupled to one of the support legs 61 of the support structure 55 of the main bearing housing 56, and at location Y the respective electrical cabinet 46 is coupled to the underside of the main bearing housing 56. In these locations, therefore, the mounting point for the electrical cabinets 46 can be considered to be on a radially inner surface of the main bearing housing 56 although the mounting points may also be on a radially inner surface of the base frame 28. By ‘radially inner surface’ it is meant a surface of the base frame 28 or the main bearing housing 56 that generally points inwards towards the central axis of the tower or is radially inboard from the radially outer parts of the base frame 28 or main bearing housing 56.

Location Z illustrates an example wherein the electrical cabinet 46 remains entirely within the interior volume 40 of the tower 12, therefore below the mounting plane 31, throughout its allowable movement. It should be noted that in location Z, the electrical cabinet 46 is coupled, either directly or indirectly, to the base frame 28 of the nacelle 14. For example, the electrical cabinet 46 could be mounted on protruding geometry, a bracket, or a pre-existing component such as a yaw claw for mounting the nacelle 14 to the wind turbine tower 12, as shown here by a dashed part denoted as ‘65’.

The proportions defining the perpendicular distance above and below the mounting plane 31 mentioned above could be modified and still yield a desirable result. For example, the perpendicular distance a could be 50%; 30%; or 20%. Likewise, the perpendicular distance β could be 0% or 10%. It is envisaged that any combination of the above values for α and β would yield an effective mounting position of the electrical cabinets 46.

It will be appreciated that in the context of the nacelle 14 described above, the invention may embrace a procedure for installing the nacelle 14 on a wind turbine tower 12. The installation procedure may commence with transporting the nacelle 14, for example from a manufacturing facility to a wind farm at which it will be installed. Prior to transport, the nacelle 14 would be configured such that the electrical cabinets 46 are arranged in the first position A, so they are nestled within the protective interior volume 38 of the nacelle 14. Once the nacelle 14 has been transported and is ready for installation, the nacelle 14 is then placed on a wind turbine tower 12 at the wind farm and coupled to said tower 12. Finally, the electrical cabinets 46 are moved from the first position A to the second position B as part of preparing the wind turbine 10 for operation. During this time, the electrical cabinets 46 remain operatively coupled to the other systems in the wind turbine nacelle to ensure that any functional testing conducted at the manufacturing facility remains valid.

An alternative example of an installation procedure could be used wherein the electrical cabinets 46 are located within the interior volume 58 of the base frame 28 throughout their respective movement. In this embodiment, the electrical cabinets 46 may leave the manufacturing facility in second position B as they would still be positioned in the protective interior volume 38 of the nacelle 14. Similar to above, the installation procedure may commence with transporting the nacelle 14, for example from a manufacturing facility to a wind farm at which it will be installed. Once the nacelle 14 has been transported and is ready for installation, the nacelle 14 is then placed on a wind turbine tower 12 at the wind farm. The electrical cabinets 46 are then moved from the second position B to the first position A to allow operators access to coupling elements, such as yaw claws and associated fasteners, that couple the nacelle 14 to the wind turbine tower 12. Finally, the electrical cabinets 46 are moved from the first position A to the second position B as part of preparing the wind turbine 10 for operation. As before, the electrical cabinets 46 remain operatively coupled to the other systems in the wind turbine nacelle to ensure that any functional testing conducted at the manufacturing facility remains valid.

The skilled person would understand that other variations and modifications may be made to the illustrated examples without departing from the scope of the invention, as defined by the claims.

For example, in the above discussion the nacelle 14 is mounted to the tower 12 by way of yaw system 24 such that the base frame 28 of the nacelle 14 acts as an interface between the nacelle 14 and the tower 12 to allow relative movement between them. It is also envisaged that the principles of the invention would also apply to other nacelle configurations which may not include a yaw system, but nevertheless include an interface between a nacelle and a support structure such as a tower, that interface including an aperture that conjoins an interior volume of the nacelle with an interior volume of the support structure. This may be the case with a so-called multi-rotor wind turbine configuration in which relatively small-sized nacelles are mounted on transverse spars that radiate outwardly from a central tower.

In the above discussion, it has been explained that the electrical cabinets 46 are movably coupled to the base frame 28 to allow them to be re-positioned between the first position A and the second position B. It should be noted that the electrical cabinets 46 are one example of wind turbine components that may be configured in this way, which is particularly convenient in the context of the yaw drives 32. However, it is also envisaged that other components other than the electrical cabinets 46 could be movably coupled in this manner to achieve the same or similar advantages. For example, it is believed that components of hydraulic systems such as pumps, hydraulic accumulators, control panels, and so on, may be movably coupled to the base frame 28 to achieve the space-saving benefits discussed above.

In a similar context, it will be appreciated that the electrical cabinets 46 such as the examples shown in FIG. 2 are not limited to hosting yaw system 24 control equipment and power electronics and that any other appropriate control electronics may be housed within the electrical cabinets 46, such as control panels for other wind turbine systems.

1. A wind turbine nacelle having a base frame, the base frame comprising a nacelle mounting ring having a mounting face adapted to be mountable to a wind turbine tower the nacelle mounting ring having an open central aperture that, in use, conjoins an interior volume of the nacelle with an interior volume, wherein the mounting face defines a mounting plane;
wherein the nacelle includes at least one electrical cabinet that is movably coupled, either directly or indirectly, to the base frame at a coupling point to move between a first and a second position; and
wherein the coupling point is located within a cylindrical volume defined by and concentric with an outer diameter of the nacelle mounting ring, and which extends upwards from the mounting plane by a perpendicular distance corresponding to 80% of the outer diameter of the nacelle mounting ring and which extends downwards from the mounting plane by a perpendicular distance corresponding to 20% of the outer diameter of the nacelle mounting ring.

2. The wind turbine nacelle of claim 1, wherein in the first position, the at least one electrical cabinet is located above the mounting plane.

3. The wind turbine nacelle of claim 1, wherein in moving to the second position the at least one electrical cabinet moves through the central aperture such that at least a portion of the at least one electrical cabinet is located below the mounting plane.

4. The wind turbine nacelle of claim 1, wherein at least one electrical cabinet is coupled, either directly or indirectly, to the base frame at the coupling point by a hinge.

5. The wind turbine nacelle of claim 1, wherein the at least one electrical cabinet relates to a wind turbine yaw system.

6. The wind turbine nacelle of claim 1, including a plurality of electrical cabinets that are movably coupled, either directly or indirectly, to the base frame at respective coupling points.

7. The wind turbine nacelle of claim 6, wherein the plurality of electrical cabinets is spaced circumferentially about the central aperture of the nacelle mounting ring.

8. The wind turbine nacelle of claim 6, wherein the plurality of electrical cabinets is arranged such that, when at least one of the movably coupled electrical cabinets is in the second position, an access space is defined between the plurality of movably coupled electrical cabinets and through the central aperture.

9. The wind turbine nacelle of claim 1, wherein the base frame (28) comprises a hollow interior space, and wherein the coupling point is adapted such that the at least one electrical cabinet is movable within the hollow interior space.

10. The wind turbine nacelle of claim 1, wherein the outer diameter of the nacelle mounting ring is greater than 2 meters.

11. The wind turbine nacelle of claim 1, wherein the at least one electrical cabinet remains operatively coupled to an electrical system within the nacelle during movement of the electrical cabinet.

12. The wind turbine nacelle of claim 1, wherein the coupling point is located on a radially inner surface of the base frame or a main bearing housing associated with the base frame.

13. The wind turbine nacelle of claim 1, wherein the cylindrical volume extends from the mounting plane and upwards therefrom by a perpendicular distance corresponding to 50% of the diameter of the nacelle mounting ring and does not extend below the mounting plane.

14. A wind turbine comprising a wind turbine nacelle in accordance claim 1.

15. A method of installing a nacelle according to claim 1 on a wind turbine tower, in which the method comprises:
transporting the nacelle to the tower in a transport condition, wherein in the transport condition the at least one movably coupled electrical cabinet is in the first position (A);
assembling the nacelle on the wind turbine tower; and
moving the at least one movably coupled electrical cabinet from the first position (A) to the second position (B).

16. A method according to claim 15, wherein in moving from the first position (A) to the second position (B), the movably coupled electrical cabinet moves at least partially through the open central aperture of the base frame.
